(19) United States
(12) Patent Application Publication
(10) Pub. No.: US 2024/0090365 A1
(43) Pub. Date: Mar. 21, 2024

(54) SEED METER CALIBRATION SYSTEM AND METHOD

(71) Applicant: Great Plains Manufacturing, Inc., Salina, KS (US)

(72) Inventors: Bruce D. Peterson, Lindborg, KS (US); Matthew D. Goodon, Salina, KS (US); James Edward Schott, McPherson, KS (US)

(21) Appl. No.: 18/470,771

(22) Filed: Sep. 20, 2023

Related U.S. Application Data
(60) Provisional application No. 63/408,147, filed on Sep. 20, 2022.

(51) Int. Cl. A01C 7/10

(52) U.S. Cl. CPC A01C 7/107; A01C 7/102

(57) ABSTRACT

A method for calibrating a seed meter. The method comprises a step of providing the seed meter and a calibration disc. The seed meter comprises a motor with a driveshaft, and the driveshaft is configured to be positioned by the motor in an uncorrected home position. An additional step includes engaging the calibration disc with the seed meter, with the calibration disc including a plurality of indicia on a surface of the calibration disc. A further step includes identifying a corrected home position for the driveshaft, with such identifying step including determining, via the calibration disc's indicia, an angular offset between the uncorrected home position and the corrected home position of the driveshaft.

### CROSS-REFERENCE TO RELATED APPLICATION

The present non-provisional patent application claims priority benefit to U.S. Provisional Patent Application Ser. No. 63/408,147, filed Sep. 20, 2022, and entitled “SEED METER CALIBRATION SYSTEM AND METHOD.” The entirety of the above-identified provisional patent application is hereby incorporated by reference into the present non-provisional patent application.

### FIELD

Embodiments of the present invention are directed to a metering system and method of use. In more detail, embodiments of the present invention are directed to a seed meter calibration system configured to calibrate a seed meter. Further, embodiments of the present invention include an operating method for using seed meters to dispense seed in an accurate manner into or onto the ground soil, with the seed meters particularly configured in a twin-row arrangement.

### BACKGROUND

Seed metering devices are well known. For instance, U.S. Pat. No. 8,375,874, which is herein incorporated by reference in its entirety, discloses a seed metering device that can be used with a planting machine. Such a seed metering device includes a seed metering disc that comprises a plurality of seed pockets on the periphery of the seed metering disc. As the seed metering disc rotates through a housing containing seed, the seed metering disc picks up the seed and retains them in the seed pockets. As the seed metering disc rotates, the seeds are held in place within the seed pockets via air-pressure. The seeds are held in place until the seeds are positioned over a dispensing tube, at which point the seeds drop under the force of gravity into the dispensing tube. The seeds then travel through the dispensing tube where they are dispensed and/or planted into or onto the ground soil.

Commonly such metering devices are powered mechanically, such as via chains that interact with gears/sprockets to drive the seed metering disc. However, newer metering devices have begun to use electric motors to drive the seed metering discs. Unfortunately, it is difficult to calibrate electric motors so that the metering devices can accurately dispense seed. Furthermore, many metering devices are configured in twin-row arrangements, such that the metering devices operate in pairs. In such twin-row arrangements, it is generally preferable for the pairs of metering devices to operate so that seeds are dispensed in a pattern having an even, staggered spacing. However, use of electric motors has introduced difficulties in establishing the precision timing necessary for the metering devices in a twin-row configuration to dispense seed in the appropriate pattern (e.g., having an even, staggered spacing).

### SUMMARY

Embodiments of the present invention include a method for calibrating a seed meter. The method comprises a step of providing the seed meter and a calibration disc. The seed meter comprises a motor with a driveshaft, and the driveshaft is configured to be positioned by the motor in an uncorrected home position. An additional step includes engaging the calibration disc with the seed meter, with the calibration disc including a plurality of indicia on a surface of the calibration disc. A further step includes identifying a corrected home position for the driveshaft, with the identifying step including determining, via the calibration disc's indicia, an angular offset between the uncorrected home position and the corrected home position of the driveshaft.

Embodiments of the present invention also include a system for calibrating a seed meter. The system comprises a housing configured to hold seed, and a disc received within the housing. The system additionally includes a motor comprising a driveshaft, with the motor being configured to rotate the disc. The disc comprises a plurality of indicia, such that the disc is configured to be used to calibrate a position of the driveshaft of the motor.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a seeding implement comprising a plurality of row units with seed meters supported by a frame of the seeding implement;

FIG. 2 is a top, plan view depiction of two pairs of row units with seed meters dispensing seed in a twin-row configuration, with a top pair of row units with seed meters dispensing seed in an even spacing pattern and a bottom pair of row units with seed meters dispensing seed in an uneven spacing pattern;

FIG. 3 is a perspective view of a portion of a seed meter including an electric motor for powering the seed meter;

FIG. 4 is an opposite side perspective view of the seed meter from FIG. 3, with a portion of a housing of the seed meter removed to view interior elements of the seed meter;

FIG. 5 is a perspective view of the motor from the seed meter from FIG. 3 shown operably engaged with a seed disc;

FIG. 6 is a is a cross section of the motor and other components from FIG. 5, with the seed disc removed;

FIG. 7 is a schematic depiction of a pair of uncalibrated seed meters;

FIG. 8 is a schematic depiction of a pair of calibrated seed meters;

FIG. 9 is a schematic depiction of a motor control unit for a motor of a seed meter;

FIG. 10 is a perspective view of a calibration disc according to embodiments of the present invention;

FIG. 11 is a schematic depiction of a calibration disc integrated with a seed meter;

FIG. 12 is a flowchart of a method for calibrating a seed meter according to embodiments of the present invention;

FIG. 13 is a schematic depiction of a row control unit in communication with a pair of seed meters;

FIG. 14 is a schematic depiction of a field having had seed deposited therein by a seeding implement, with the seed having been deposited while the seeding implement was performing a right turn;

FIG. 15 is a schematic depiction of a pair of seed meters in a twin-row configuration depositing seed in a pattern having an even, staggered spacing; and

FIG. 16 is a flowchart of a method for operating a pair of seed meters in a twin-row configuration according to embodiments of the present invention.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

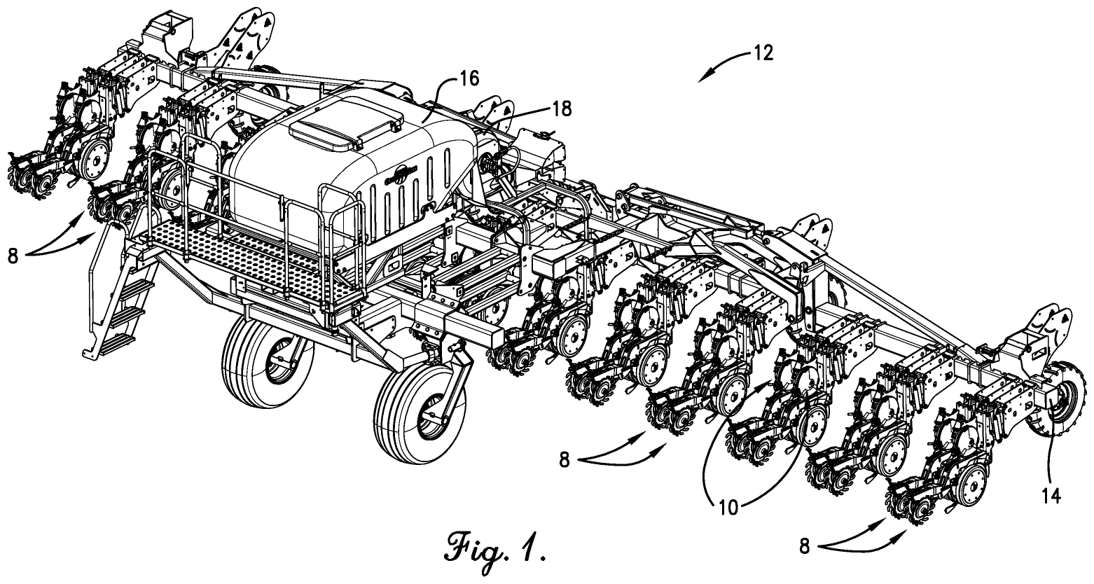

The present invention broadly provides various embodiments of a seed meter calibration system and a method of operating seed meters. In more detail, and with reference to FIG. 1, a plurality of exemplary row units 8 (each including a seed meter 10) are illustrated as part of a seeding implement 12. The seeding implement 12 may comprise a seeder that includes a frame 14 that supports the plurality row units 8, at least one bin 16 for holding seed (or other particulate material, such as fertilizer, plant nutrients, etc.), an air pressure device 18 (pneumatic pump, an air compressor, a vacuum pump, a fan or the like) for producing an air-pressure differential within the seed meters 10. In operation, the seeding implement 12 is configured to dispense seeds in a controlled manner into or onto the ground soil of a field for planting.

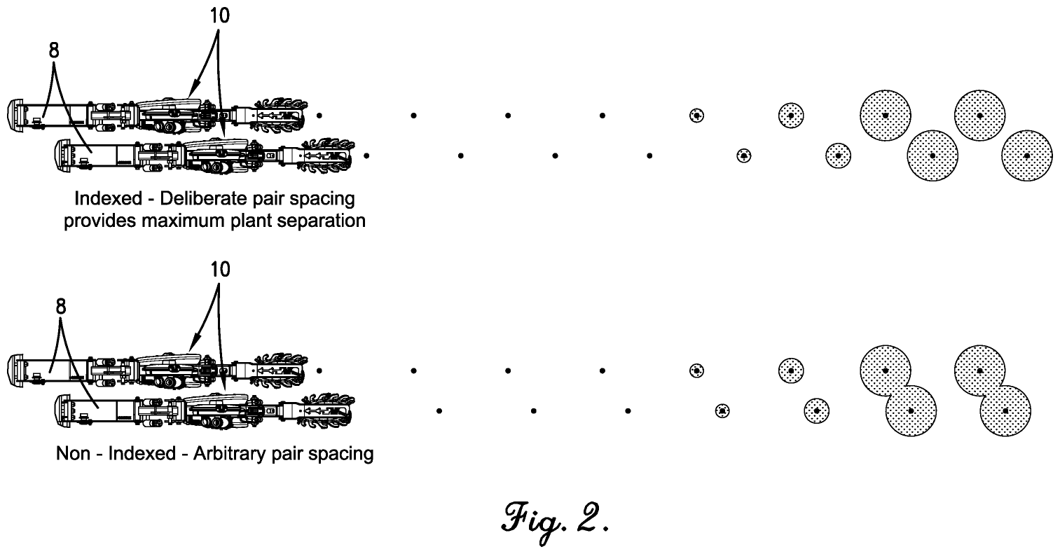

The seeding implement 12 may be connected to a towing unit (e.g., a tractor not shown in the drawings) for pulling or pushing the seeding implement 12 during operation. Exemplary seeding implements are described in U.S. Pat. Nos. 6,308,645 and 5,497,715, which are herein incorporated by reference in their entireties. As mentioned above, the seed seeding implement 12 may include a plurality of row units 8 attached to the frame 14. Each of the row units 8 is configured for dispensing seeds one at a time (i.e., singulating) into or onto the ground soil. As illustrated in FIG. 2, row units 8 may, according to certain embodiments of the present invention, generally be arranged in pairs so as to operate in what is commonly referred to as a twin-row configuration. In such embodiments, the row units 8 may be mounted to the frame 14 of the seeding implement 12 in pairs. For instance, the pairs of row units 8 may each be at least partially interconnected via a bracket that can be secured to the frame 14 (See, e.g., FIG. 1). In some embodiments, the brackets will secure one of the row units 8 of each pair at least partly forward (with respect to a travel direction of the seeding implement 12) of the other row unit 8, so as to provide for a front row unit 8 (which includes a front seed meter 10) and a rear row unit 8 (which includes a rear seed meter 10). In the twin-row configuration, the seeding implement 12 is configured to dispense seed in a plurality of twin rows within the ground soil, as illustrated in FIG. 2.

As noted above, each of the row units 8 may comprise a seed meter 10 that is configured to dispense seed from the row unit 8 into and/or onto the ground. A goal of the seed meters 10 of the row units 8 in the twin-row configuration is to singulate and drop seeds in a way that provides a desired number of seeds per acre and a uniform spacing (i.e., staggered and equidistant) between the seeds as they are placed in the ground soil. As illustrated by the top pair of row units 8 in FIG. 2, a uniform spacing is provided whereby each seed meter 10 of the row units 8 dispenses seed at the same interval. Furthermore, each seed meter 10 of a given row unit 8 should preferably be configured to dispense seed equally between (with respect to a travel direction of the row units 8) the seeds that are dispensed by the seed meter 10 of the other row unit 8 of a given pair of row units 8. For example, the top pair of row units 8 illustrated in FIG. 2, show the pair of seed meters 10 dispensing seed at the same interval, and each seed meter 10 dispensing seed equally between the seed that is dispensed by the other seed meter 10. As such, the resulting plants that grow from the planted seed have maximal access to space, soil, sunlight, etc. (as illustrated in FIG. 2). In contrast, the bottom pair of row units 8 illustrated in FIG. 2, show the pair of seed meters 10 dispensing seed at arbitrary positions into/onto the ground soil. As such, the resulting plants that grow from the seed have inefficient access to space, soil, sunlight, etc. (as illustrated in FIG. 2) because the plants are overlapping and growing into each other, taking each other's resources.

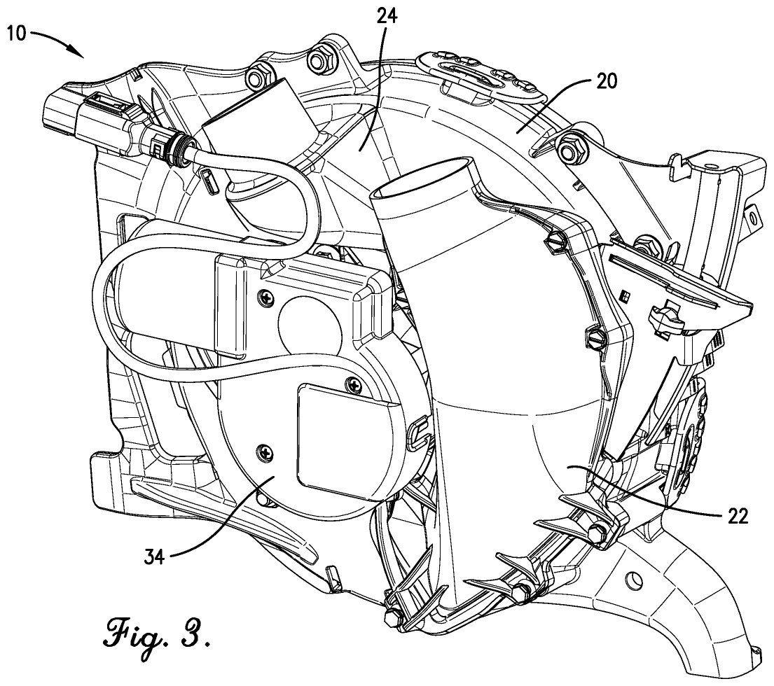

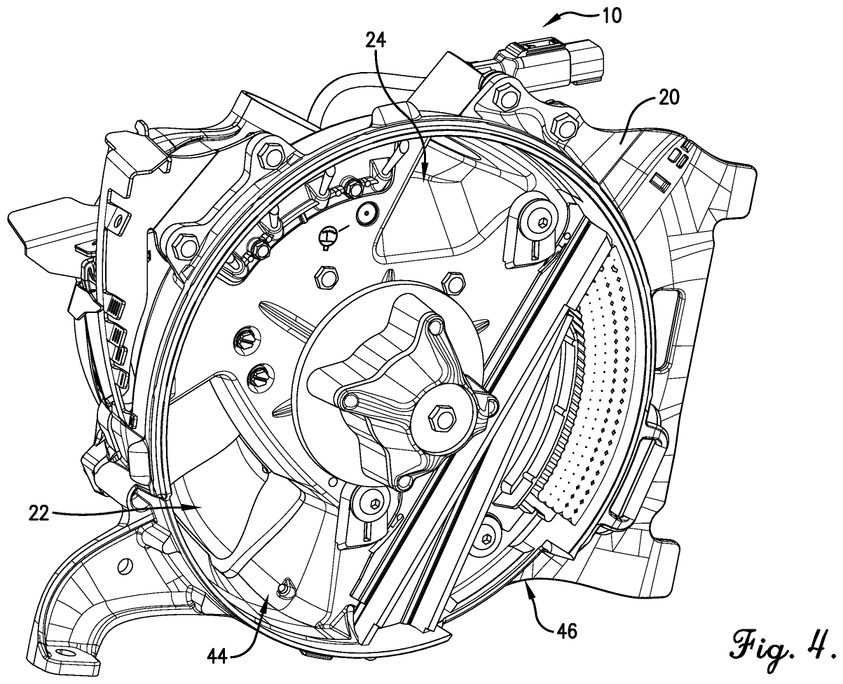

Turning to the individual seed meters 10 in more detail, and with reference to FIGS. 3 and 4, each seed meter 10 generally comprises a circular housing 20 having a seed inlet 22 and an air inlet 24. As such, the seed meter 10 is configured to receive seed via the seed inlet 22 and is configured to receive pressurized air via the air inlet 24. Conduits, such as piping, tubing, hose, or the like, and may be used to connect the seed bin 16 to the seed inlet 22 of the seed meter 16 so as to provide seed into the housing 20. Similarly, conduits, such as piping, tubing, hose, or the like, and may be used to connect the air pressure device 18 to the air inlet 24 of the seed meter 10 so as to generate a relative air pressure differential within the housing 20 (i.e., with respect to an ambient air pressure).

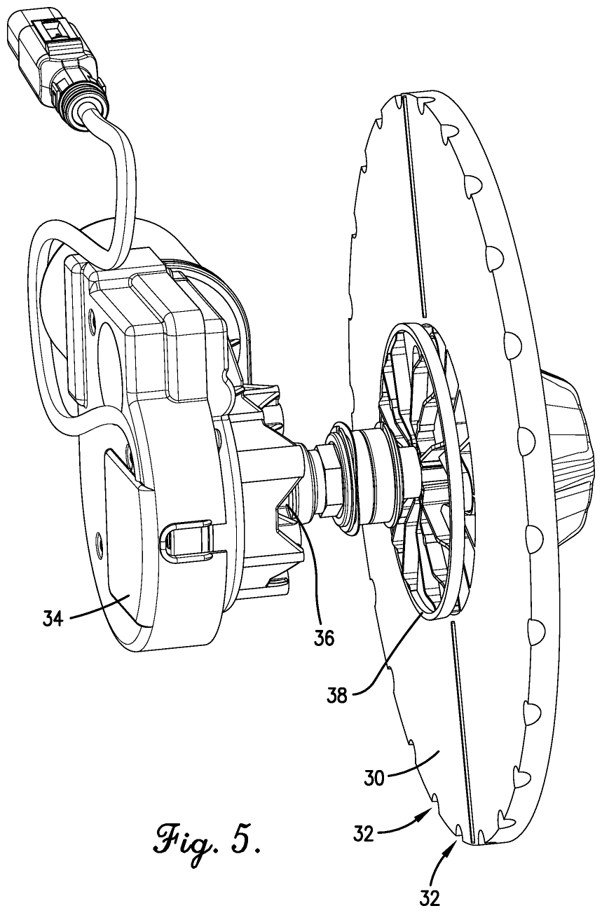

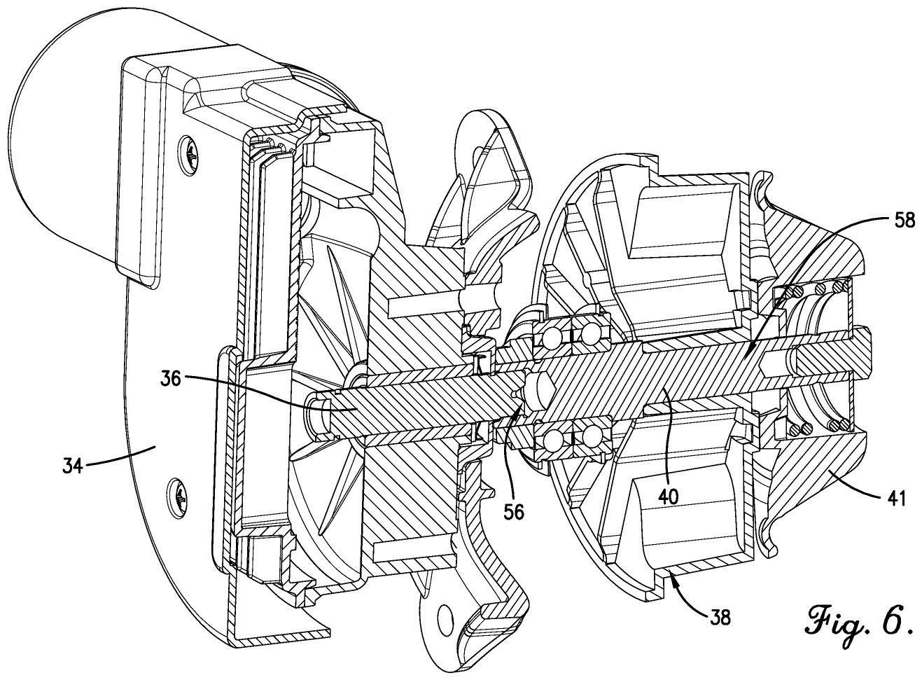

Each seed meter 10 will include a seed disc 30, as perhaps best illustrated by FIG. 5, that is configured to be positioned within the interior space of the housing 20 (the open housing 20 of the seed meter 10 is illustrated in FIG. 4) and rotated therein. The seed disc 30 may include a plurality of seed pockets 32 spaced around a circumference of the outer surface of the seed disc 30. Such seed pockets 32 may, however, be positioned at various locations on the surface/face of the seed disc 30, even spaced away from the outer perimeter or edge. Various types of seed discs 30 may individually be formed with pockets 32 of different shapes and sizes to accommodate different types of seeds and different sizes of seeds. The seed disc 30 is configured to rotate within the housing 20 via power provided by a motor 34, as perhaps best illustrated in FIGS. 3, 5, and 6. In some embodiments, the motor 34 will comprise an electric motor and may be secured to an exterior of the housing 20. As best shown in FIGS. 5 and 6, the motor 34 includes a driveshaft 36 that extends toward the seed disc 30.

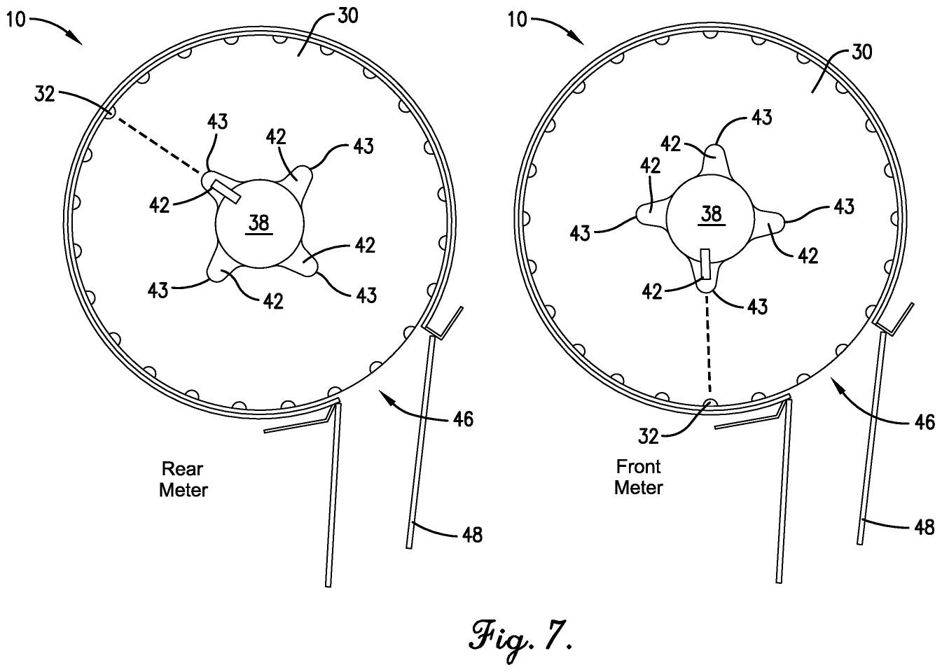

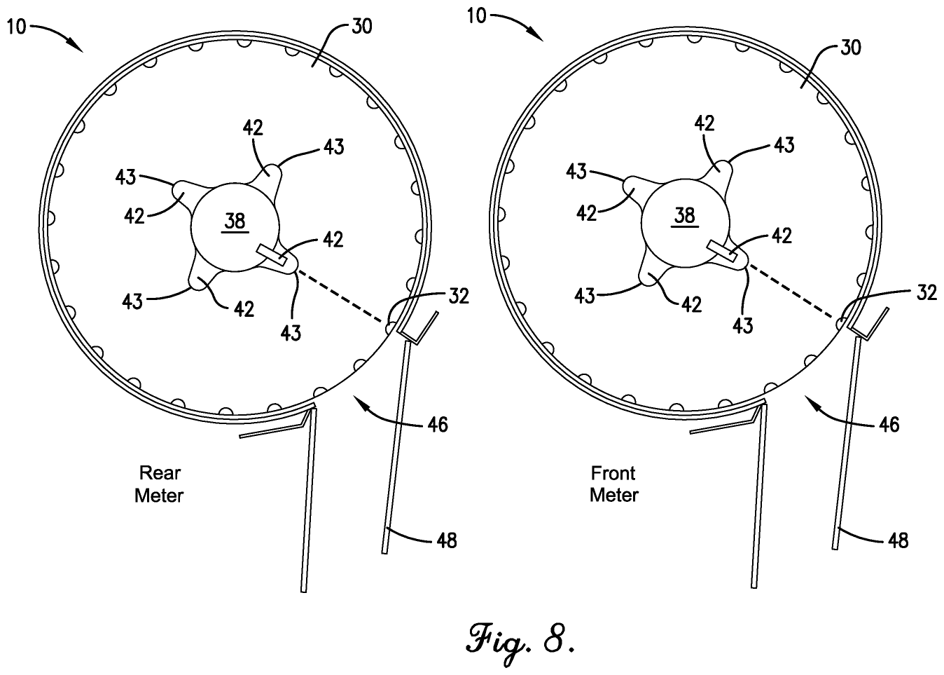

The seed disc 30 is secured in place within the housing 20 via a disc seat 38, over which an open center portion of the seed disc 30 is configured to be removably engaged (See FIGS. 5 and 6). A disc shaft 40 extends through a center of the disc seat 38 and is configured to engage with the driveshaft 36 of the motor 34, as shown in FIG. 6. As such, rotation of the driveshaft 36 (by the motor 34) causes a corresponding rotation of the disc shaft 40, the disc seat 38, and the seed disc 30. The seed disc 30 may be held in place on the disc seat 38 via a hub 41 that is threadedly engaged with the disc seat 38 and/or the disc shaft 40, such that the seed disc 30 is sandwiched between the disc seat 38 and the hub 41. In some embodiments, as illustrated in FIGS. 7 and 8, the disc seat 38 may include one or more lobes 42 (e.g., projections) that correspond with grooves 43 formed within the center portion of the seed disc 30. The engagement between the lobes 42 and the grooves 43 assist in aligning the seed disc 30 onto the disc seat 38 and/or permitting the disc seat 38 to impart rotation onto the seed disc 30. Furthermore, as shown in FIGS. 7 and 8, one or more (e.g., all) of the lobes 42 and/or the grooves 43 may be aligned with a center of one of the seed pockets 32. Specifically, a radially extending line passing through a tip of one of the lobes 42 and/or a base of one of the grooves 43 will also generally extend through a center of one of the seed pockets 32.

With reference to FIG. 4, the interior workings of the seed meter 10 will now be described in detail. Seed enters the first seed inlet 22 and fills a seed pool cavity 44. The seed disc 30 is operable to rotate within the housing 20 through the seed pool cavity 44. As such, seeds are captured by the seed pockets 32 of the metering disc 30, and carried along during the rotation of the seed disc 30. The seeds may be retained in the seed pockets 32 via an air-pressure differential created by the air pressure device 18 fluidly connected to the first air inlet 24. As such, embodiments provide for a positive air-pressure differential to be produced between the interior of the housing 20 and the exterior of the housing 20. The air-pressure differential between the housing 20 and the ambient is sufficient to retain the seeds within the seed pockets 32 of the first metering disc 30 while the metering disc 30 rotates through the housing 20. The seed disc 30 rotates the seeds within the seed pockets 32 until the seeds are positioned over a seed outlet 46 of the housing 32. The seed outlet 46 opens into a seed tube 48 (See FIGS. 7 and 8) that extends down from the housing 20 to a position adjacent to the ground soil. Once over the seed outlet 46, the seeds will drop down the dispensing tube 48, due to gravity, where the seeds are dispensed into or onto the ground soil.

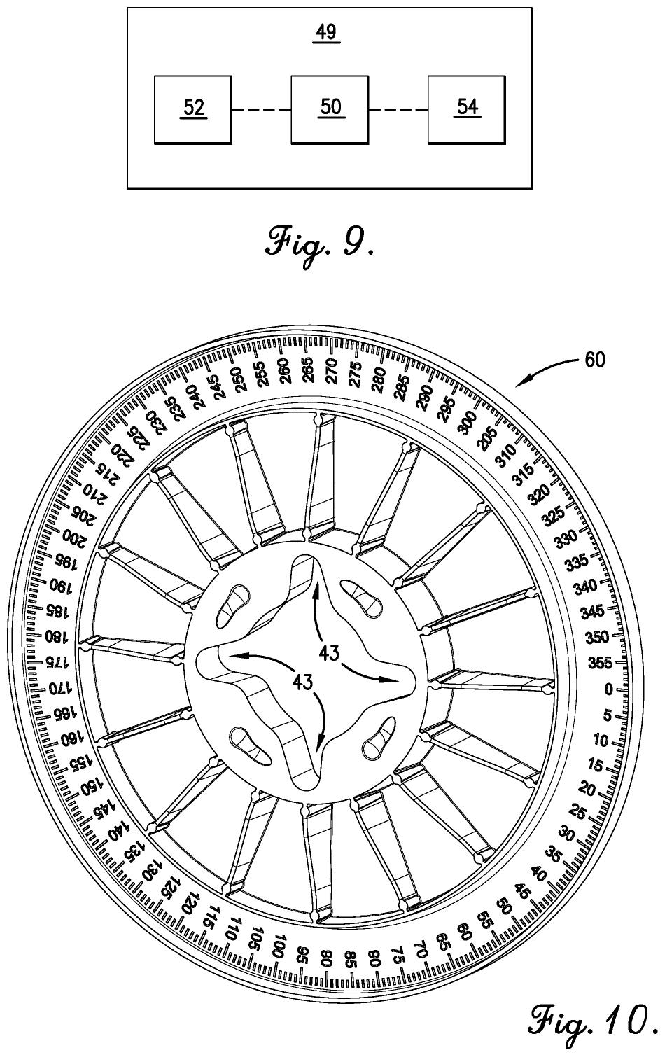

Returning to the motor 34 in more detail, as noted above, the motor may comprise an electric motor configured to accurately rotate the driveshaft 36 (and thus the seed disc) to specific angular positions or a at specific angular speeds. Each motor 34 may include a motor control unit 49 (MCU) that is integrated with the motor 34. The MCU 49 may be physically integrated with and/or within the motor 34. As illustrated by FIG. 9, the MCU 49 may comprise one or more processing elements 50, one or more memory elements 52, and an encoder 54. The processing elements 50 may implement operating systems, and may be capable of executing a computer program (that may be stored on the memory elements 52), which is also generally known as instructions, commands, software code, executables, applications, apps, and the like. The processing elements 50 may include processors, microprocessors, microcontrollers, field programmable gate arrays, and the like, or combinations thereof. The memory elements 52 may be capable of storing or retaining the computer program and may also store data, typically binary data, including text, databases, graphics, audio, video, combinations thereof, and the like. The memory elements 52 may also be known as a “computer-readable storage medium” and may include random access memory (RAM), read only memory (ROM), flash drive memory, floppy disks, hard disk drives, and the like, or combinations thereof. Thus, various of the methods, processes, and/or steps discussed herein may be performed by the MCU 49 executing the instructions of a computer program.

The encoder 54 of the MCU 49 of the motor 34 may comprise various types of encoders known in the art, which are configured to monitor a position of the driveshaft 36 of the motor 34. In some embodiments, the encoder 54 may comprise a magnetic encoder or an optical encoder. Using the encoder 54 the MCU 49 may be configured to determine a position and/or a speed of the driveshaft 36 (and thus the seed disc 30).

Generally, the MCU 49 of the motor will be configured to accurately control the position of the seed disc 30 by basing the position/speed of the driveshaft 36 (and thus the seed disc 30) on the position of the driveshaft 36 obtained from the encoder 54. However, there has been found a need to calibrate each seed meter 10 in certain instances, such as on the manufacture of a seed meter 10, replacement (or other removal) of the motor 34, and/or replacement (or other removal) of the disk seat 38. In more detail, although the encoder 54 is configured to accurately measure the position of the driveshaft 36, there is some variability or “play” in various connections between the driveshaft 36 and the seed disc 30, such that it is difficult to accurately measure the position of the seed disc 30. For example, and with reference to FIG. 6, the driveshaft 36 may be engaged with the disc shaft 40 at a first splined joint 56. The orientation and/or spacing of the splines within the first splined joint 56 may vary based on manufacturing capabilities. In addition, the disc shaft 40 may be engaged with the disc seat 38 via a second splined joint 58 comprising the engagement between splines (formed on the surface of the disc shaft 40) and index flats formed on the disc seat 38. The orientation and/or spacing of the splines within the second splined joint 58 may vary based on manufacturing capabilities.

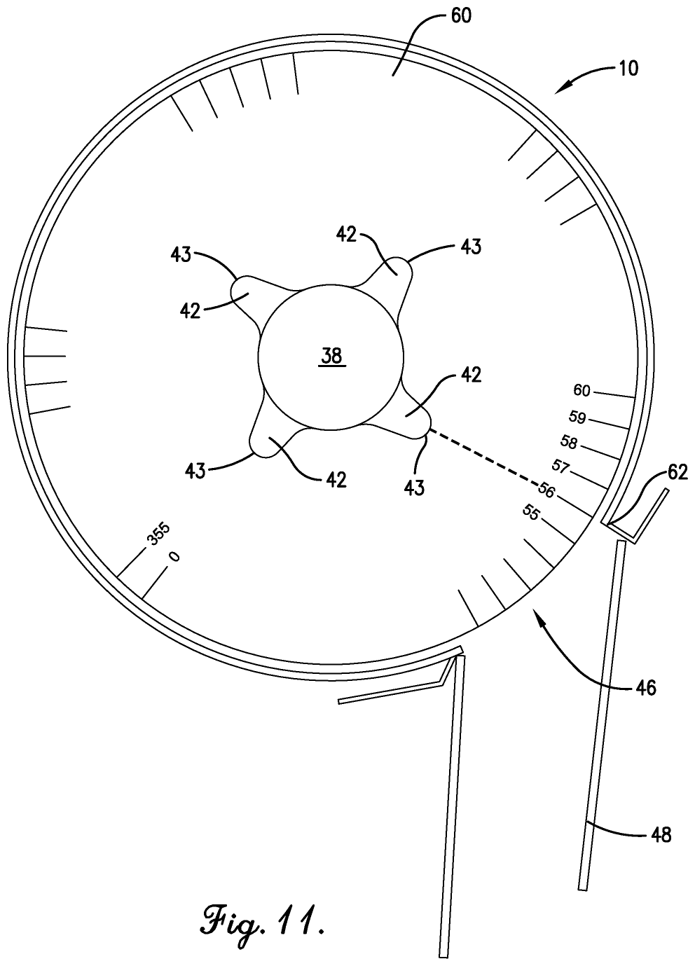

To facilitate calibration of the seed meters 10, embodiments of the present invention comprise a calibration disc 60, as illustrated in FIGS. 10 and 11. With reference to FIG. 10, the calibration disc 60 may comprise a generally circular disc with a plurality of indicia formed on the surface of the calibration disc 60. In some embodiments, the indicia may be markings printed, or otherwise formed, on a surface of the calibration disc 60. In certain embodiments, the indicial may be engraved onto the surface of the calibration disc 60. In some embodiments, the indicia of the calibration disc 60 may be formed at least partly around a circumference of the calibration disc 60, near a perimeter of the calibration disc 60. For instance, the indicia may comprise angular measurement identifiers that extend around the entire perimeter or circumference of the calibration disc 60, so as to provide numerical angular increments from zero degrees to three-hundred sixty degrees (representative of the full number of angular degrees around the disc). In other embodiments, the indicia may only extend around a portion (e.g., one-quarter or one-half) of the perimeter or circumference of the calibration disc 60.

In some embodiments, the calibration disc 60 may not include seed pockets 32, but may otherwise be configured similar to the size and shape of the seed disc 30. For example, a center of the calibration disc 60 may include an opening with similarly-shaped grooves 43 as the seed disc 30 (See, e.g., FIG. 10). As illustrated in FIG. 11, the central opening of the calibration disc 60 is configured to be received over the disc seat 38 of the seed meter 10, such that the grooves 43 of the calibration disc 60 are received by the lobes 42 of the disc seat 38. As such, the calibration disc 60 may be held in place on the disc seat 38 via the hub 41 that sandwiches the calibration disc 60 between the disc seat 38 and the hub 41. Notably then, each of the seed disc 30 and the calibration disc 60 is configured to be removably engaged with the remaining components of the seed meter 60 by removing (e.g., unlocking or unthreading) the hub 41 to release the disc 30, 60, such that the disc 30, 60 can be removed. Furthermore, as shown in FIG. 11, at least one of the grooves 43 of the calibration disc may be aligned with one of the indicia. Specifically, for example, a radially extending line passing through the base of one of the grooves 43 will also generally extend through one of the indicia. In some embodiments, as illustrated in FIG. 10, one of the grooves 43 will be aligned with an “initial indicia” of the angular measurements (e.g., the zero “0” degrees indicia). Finally, it should be understood that although the calibration disc 60 is generally described herein as being a separate disc from the seed disc 30, embodiments may provide for the calibration disc itself to be a seed disc. Specifically, in some embodiments, the calibration disc may comprise a seed disc with a plurality of pockets for carrying seeds, but may also include the plurality of indicia such that the calibration disc can be used to calibrate the seed meter 10 (in addition to carrying seed in the seed pockets). In such embodiments, the seed meter calibration system may include only a single disc that functions as both a seed disc and a calibration disc.

It is noted that the MCU 49 of a given seed meter 10 and/or motor 34 will initially store (e.g., in the memory elements 52 upon manufacture/assembly of the seed meter 10) an uncorrected home position of the driveshaft 36 of the motor 34. Such uncorrected home position (or other positions of the driveshaft 36) may be determined by the encoder 54. FIG. 7 illustrates a pair of seed meters 10 (e.g., a pair of seed meters 10 in a twin-row arrangement) with the respective motors 34 (not shown) positioning respective driveshafts 36 (not shown) in uncorrected home positions. Given the issues noted above with respect to variability or “play” in various connections of the seed meters 10, as well as the various orientations in which the seed discs 30 can be situated onto the disc seat 38 (e.g., up to four different orientations), the seed discs 30 are oriented in random positions. Thus, for accurate operation of the seed meters 10, it is necessary to calibrate the seed meters 10, such that the seed discs 30 can each be oriented in a specific position (e.g., a calibrated home position), exemplarily illustrated in FIG. 8. It is noted that the schematic depiction of the seed meters 10 in FIGS. 7 and 8 illustrates the seed meters 10 moving in a left to right direction of travel, such that the left seed meter is a rear seed meter 10 and the right seed meter is a front seed meter 10.

To begin the calibration of the seed meter 10, electric power is provided to the motor 34 and the motor 34 is instructed to position the driveshaft 36 in the uncorrected home position. If the seed disc 30 is installed in the seed meter 10 (e.g., on the disc seat 38), the seed disc 30 is removed, and the calibration disc 60 is installed in the seed meter 10 (e.g., on the disc seat 38), as illustrated in FIG. 11. If the seed disc 30 is not installed in the seed meter 10, then the calibration disc 60 can simply be installed. Still otherwise, the motor 34 can be instructed to position the driveshaft 36 in the uncorrected home position with the calibration disc 60 being installed in the seed meter 10. With the calibration disc 60 installed on the seed meter 10, an operator can identify one of the plurality of indicia that is positioned at a given location with respect to the seed meter 10. For example, as illustrated in FIG. 11, the given location may be a lip 62 or edge of the seed outlet 46 formed in the housing 20. Specifically, a user may visually identify which indicia is aligned with and/or positioned adjacent to the lip 62. When the indicia comprise angular measurements, the identified indicia (e.g., the “56” indicia shown in FIG. 11) will indicate an angular offset, which is a calibration offset that can be used to convert between the uncorrected home position of the driveshaft 36 of the motor 34 and a corrected home position of the driveshaft 36 of the motor 34.

For example, if the user identifies the “56” indicia shown in FIG. 9 as being adjacent to the lip 62, the user understands that the corrected home position is 56 degrees offset from the uncorrected home position. Such a calibration offset can be entered into and stored by the memory elements 52 of the MCU 49 of the motor 34, so that the MCU 49 can automatically position the driveshaft in the corrected home position (or other relative position) when necessary.

Once the calibration offset has been determined and stored in the MCU 49 of the motor 34, the calibration disc 60 can be removed and the seed disc 30 can be installed onto the remaining components of the seed meter 10. With the seed disc 30 installed, the motor 34 can, using the calibration offset, position the driveshaft 36 in the corrected home position. It is noted that with the driveshaft 36 in the corrected home position, the seed disc 30 will be in the calibrated home position. Specifically, due to the base of one of the grooves 43 of the calibration disc 60 being aligned with the initial indicia (e.g., the zero degrees indicia), then the tip of one of the lobes 42 of the disc seat 38 will also be aligned with the initial indicia. As such, when the seed disc 30 replaces the calibration disc 60 on the disc seat 38, and when the motor 34 translates the seed disc 30 to the home position, one of the seed pockets 32 will be aligned with the lip 62 of the seed outlet 46 formed in the housing 20. Each of the seed meters 10 associated with the seeding implement 12 can be calibrated in the same manner, and with the same calibration disc 60.

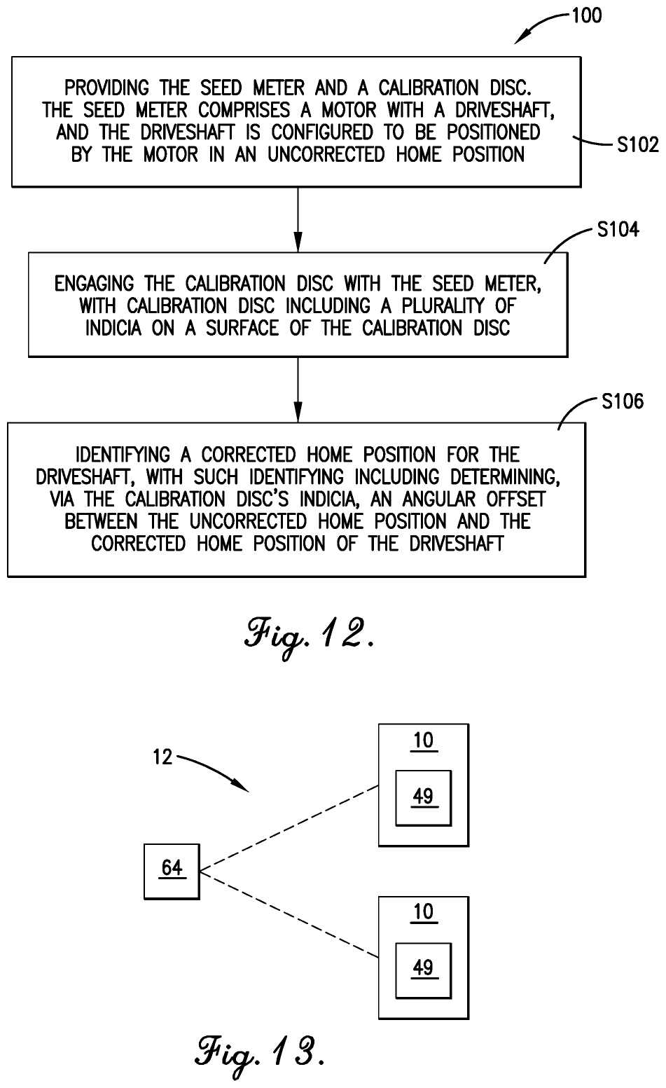

In view of the above, embodiments of the present invention include a method 100, as illustrated in FIG. 12, for calibrating a seed meter. The method comprising a step S102 of providing the seed meter and a calibration disc. The seed meter comprises a motor with a driveshaft, and the driveshaft is configured to be positioned by the motor in an uncorrected home position. An additional step S104 includes engaging the calibration disc with the seed meter, with calibration disc including a plurality of indicia on a surface of the calibration disc. A further step S106 includes identifying a corrected home position for the driveshaft, with such identifying including determining, via the calibration disc's indicia, an angular offset between the uncorrected home position and the corrected home position of the driveshaft. As was noted above, in some embodiments, the calibration disc may be a disc separate from a seed disc of the seed meter or may itself be a seed disc (i.e., the calibration disc is a combination seed disc and calibration disc). In the latter scenario, with the calibration disc being a combination seed disc and calibration disc, the applicable system may only require the use of one disc instead of two. Furthermore, in some such embodiments, such a combined disc (e.g., combination seed disc and calibration disc) may not need to be removed from the seed meter 10, such that the disc is not removable from the seed meter 10.

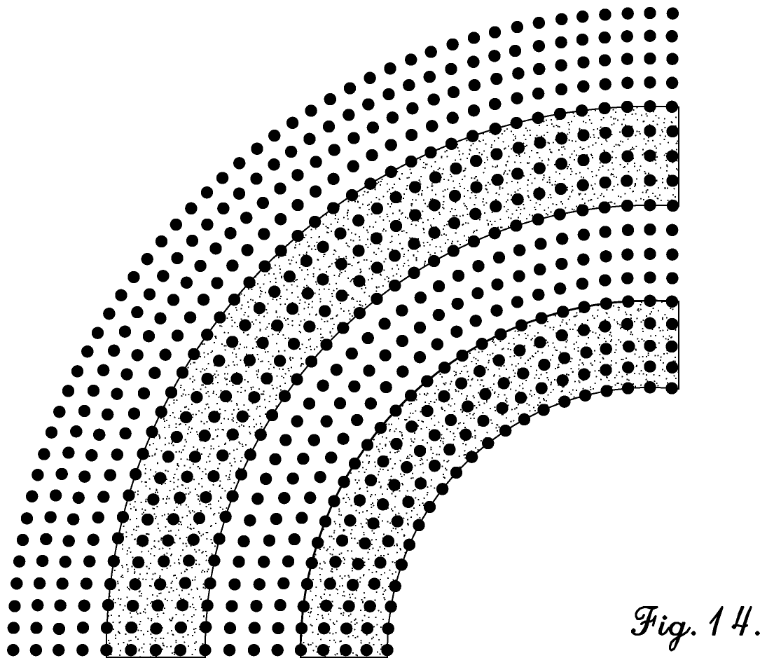

As noted above, and as illustrated by FIG. 2, the seeding implement 12 can be configured to perform planting operations in a twin-row arrangement by grouping the row units 8 (and associated seed meters 10) into pairs. Each of the seed meters 10 will be powered by its own motor 34 (which includes its own MCU 49, as previously described). In some embodiments, the seeding implement 12 will further comprise a row control unit 64 (RCU) for each pair of seed meters 10 in the twin-row configuration, as illustrated in FIG. 13. The RCU 64 may generally be configured to communicate with and/or provide control signals to the MCUs 49 of the pair of seed meters 10 with which the RCU 64 is associated. The RCU 64 may be in communication with each of the MCUs 49 of the pair of seed meters 10 via a controller area network bus (“CAN bus”). In some embodiments, the RCU 64 may also provide electric power to the motors 34 of the associated pair of seed meters 10. In some embodiments, the RCU 64 may include one or more processing elements and memory elements, which may be similar to the corresponding elements discussed above with respect to the MCU 49. As such, various of the methods, processes, and/or steps discussed herein may be performed by the processing element of the RCU 64 executing the instructions of a computer program stored on the memory elements of the RCU 64. Alternatively, or in addition, various of the methods, processes, and/or steps discussed herein may be performed by the processing elements of the MCUs 49 executing the instructions of a computer program stored on the memory elements of the MCUs 49. In still other alternatives, or in addition, some parts of the various methods, processes, and/or steps discussed herein may be performed by the RCU 64 executing the instructions of a computer program stored on the memory elements of the RCU 64, while other parts of the various the methods, processes, and/or steps discussed herein may be performed by the processing elements of the MCUs 49 executing the instructions of a computer program stored on the memory elements of the MCUs 49. Furthermore, it is noted that the seeding implement 12 may include a main electronic control unit that is communication with each of the RCUs 64 of the seeding implement 12 (with each RCU 64 being associated with a given pair of seed meters 10 in a twin-row configuration), so as to provide for communication, power, and/or control to the RCUs 64.

Given a pair of seed meters 10 arranged in a twin-row configuration, it is preferable that the seed meters 10 dispense seed in at a specified number of seeds per acre and having a uniform spacing between the seeds (i.e., staggered and equidistant), as they are placed into or onto the ground soil. Specifically, each seed meter 10 of a given pair should preferably be configured to dispenses seed equally between (with respect to a travel direction of the seed meters 10) the seeds that are dispensed by the other seed meter 10 (as illustrated by the top pair of row units 8 and associated seed meters 10 shown in FIG. 2). To accomplish such precise control of the seed meters 10, embodiments of the present invention include a novel control method discussed in more detail below.

In particular, each pair of seed meters 10 in the twin-row configuration will comprise a first seed meter 10 that is positioned forward of a second seed meter 10 (with respect to a travel direction of the seeding implement 12). As such, the first seed meter 10 will be referred to as a front meter 10, and the second seed meter 10 will be referred to as a rear meter 10. Dispensing of seed from the front meter 10 will generally be controlled by controlling the speed at which the motor 34 of the front meter 10 rotates the seed disc 30. Such control is generally based on a required seed population and a travel speed of the front meter 10. The seed population is generally established at a particular number of seeds per acre, while the travel speed of the front meter 10 may be determined by one or more speed sensors associated with the front meter 10 or otherwise with the seeding implement 12 (e.g., located on the frame 14 of the seeding implement 12 near or aligned with the front meter 10). In some embodiments, the speed sensors may comprise radar sensors configured to measure how fast the seeding implement 12 is traveling over the ground. As such, to maintain a given seed population, the motor 34 of the front meter 10 will need to rotate the seed disc 30 faster when the travel speed of the front meter 10 increases, and will need to rotate the seed disc 30 slower when the travel speed of the front meter 10 decrease. For example, as illustrated in FIG. 14, a front meter 10 positioned on a left side of the frame 14 of the seeding implement may need to dispense seed at a faster rate when the seeding implement performs a right turn (so as to maintain the required seed population). In contrast, a front meter 10 positioned on a right side of the frame 14 of the seeding implement may need to dispense seed at a slower rate when performing the right turn (so as to maintain the required seed population).

In some embodiments, control of the front meter 10 will be performed by the MCU 49 of the front meter 10 and/or by the RCU 64 associated with the pair of seed meters 10 with which the front meter 10 is associated. For instance, the speed sensor may transmit a speed measurement for the front meter 10 to the RCU 64 (e.g., via the ECU of the seeding implement 12). The RCU 64 may send instructions to the MCU 49 for the motor 34 of the front meter 10 to speed up or slow down the rotation of the seed disc 30 based on the speed measurement. In other embodiments, the RCU 64 may simply send the speed measurement to the MCU 49, and the MCU may independently determine whether to increase or decrease the speed of the seed disc 30.

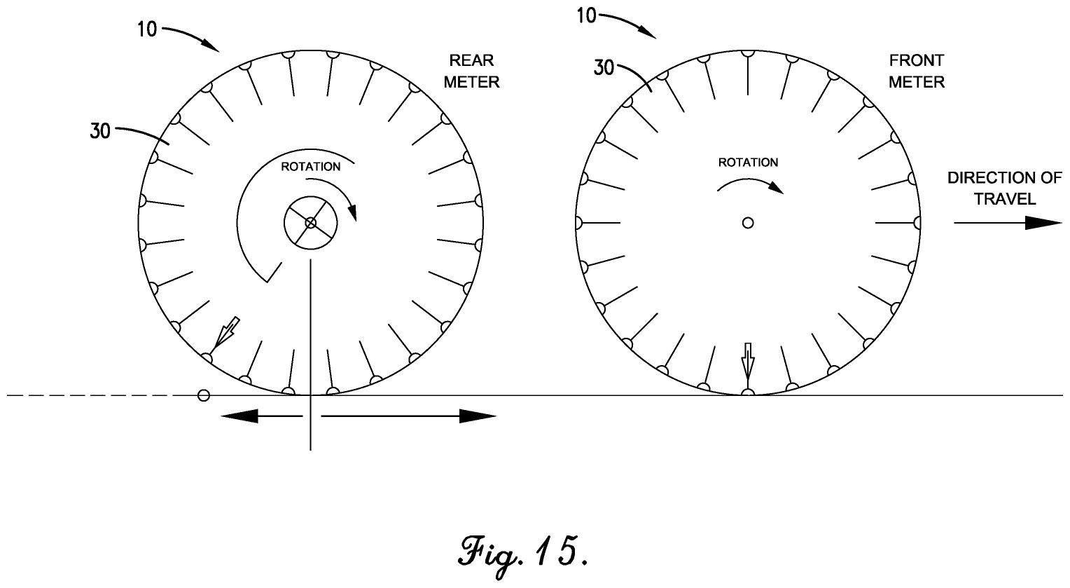

To ensure proper spacing (i.e., staggered and equidistant) is maintained between the seeds dispensed by the front meter 10 and the seeds dispensed by the rear meter 10 (e.g., equally between each other), embodiments provide for the position of the motor 34 and/or seed disc 30 of the rear meter 10 to be controlled based on the position of the motor 34 and/or seed disc 30 of the front meter 10. For example, as illustrated by FIG. 15, at the moment the front meter 10 deposits a seed onto a first location on the ground, the rear meter 10 requires information as to the position of the seed disc 30 of the front meter 10 so that the rear meter 10 can precisely control the position of the seed disc 30 of the rear meter 10 to deposit a seed in the requisite staggered, equidistant second location on the ground. Thus, control of the front meter 10 and the rear meter 10 will be in a master-slave relationship.

In more detail, the MCU 49 of the motor 34 of the front meter 10 will periodically measure a position (e.g., in degrees) of the driveshaft 36 via the encoder 54, and transmit such position data to the MCU 49 of the motor 34 of the rear meter 10 via a CAN message. In some embodiments, the position data in the CAN message will be accompanied by timing data (e.g., a timestamp in microseconds) indicative of the time when the position of the driveshaft 36 was measured. Such a CAN message (comprising position and timing data) may be transmitted to the rear meter 10 four times per second. Although other transmission periods may be used. In some embodiments, such transmissions will be sent from the MCU 49 of the motor 34 of the front meter 10 to the MCU 49 of the motor 34 of the rear meter 10 through the RCU 64 (e.g., via the CAN bus).

For each of the CAN messages received by the rear motor 10, the MCU 49 of the motor 34 of the rear meter 10 will measure a position (e.g., in degrees) of its own driveshaft 36 via the encoder 54, and also record its own timing data (e.g., a timestamp in microseconds) indicative of the time when the position of the driveshaft 36 was measured. From the current and previously received CAN messages, the MCU 49 of the rear meter 10 can calculate the current speed of the motor 34 of the front meter 10 (and thus the driveshaft 36 and seed disc 30) and extrapolate a current position of the motor 34 of the front meter 10 (and thus the driveshaft 36 and seed disc 30). The MCU 49 of the rear motor 34 can then calculate an angular offset, in the form of an “operational offset” necessary to dispense seed in the appropriately spaced manner (i.e., staggered and equidistant) with respect to the seed dispensed by the front meter 10. In some embodiments, such a calculation will use the formula:

Operational Offset=(((43560/POPULATION)*(1/(ROW_SPACING/12))*12)−STAGGER)/PERIMETER*360

where POPULATION is the intended seed population, in seed per acre, for the seeding implement 12; ROW SPACING is the distance, in inches, between each of the twin rows of seed being planted by the seeding implement 12; STAGGER is the distance, in inches, between the front meter 10 and the rear meter 10; and PERIMETER is the distance, in inches, of the perimeter of the seed disc 30 used by the rear meter 10. It is noted that the variables described above (e.g., POPULATION, ROW SPACING, STAGGER, and PERIMETER) may be stored in the memory elements 52 of the MCU 49. As such, the MCU 49 of the motor 34 of the rear meter 10 can compare the calculated angular offset with the current position (or offset) of the driveshaft 36 and/or seed disc 30 of the rear meter 10. If any error is determined, the MCU 49 can cause the motor 34 to speed up or slow down (e.g., such as via a PID controller) to obtain and/or maintain the necessary angular offset. Such calculations and determinations may be made by the MCU 49 of the motor 34 of the rear meter 10 for every CAN message received from the front seed meter 10.

In some alternative embodiments, the MCUs 49 of the front and rear meters 10 may communicate with their associated RCU 64, such that the RCU 64 may perform the necessary calculations and may provide control instructions to the meters 10. As such, the variables described above (e.g., POPULATION, ROW SPACING, STAGGER, and PERIMETER) may be stored in the memory elements of the RCU 64. The RCU 64 of a given pair of seed meters 10 can perform the necessary calculations and compare the calculated angular offset with the current position (or offset) of the driveshaft 36 and/or seed disc 30 of the rear meter 10. If any error is determined, the RCU 64 can cause the motor 34 to speed up or slow down (e.g., such as via a PID controller) to obtain and/or maintain the necessary angular offset. Such a configuration may be efficient in that the RCU 64 also may normally receive the speed measurement information for the meters 10 via the speed sensors.

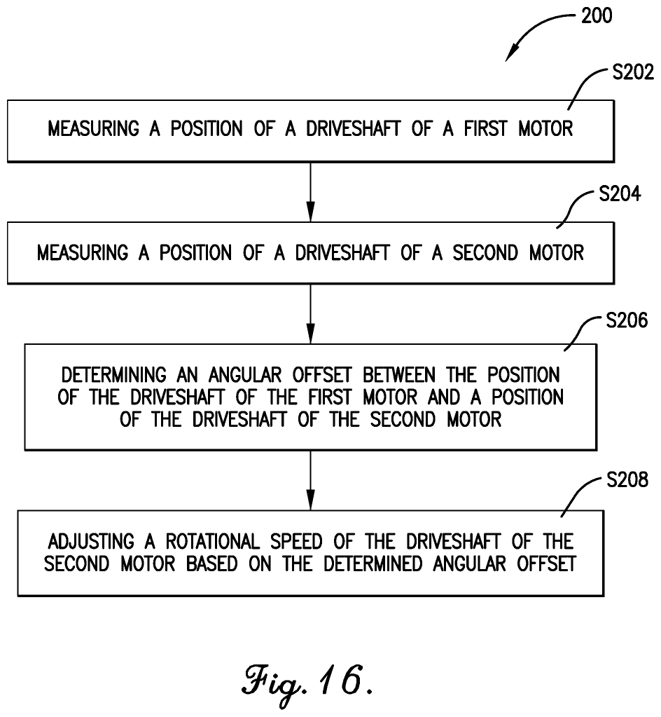

In view of the above, embodiments of the present invention may include a method 200, as illustrated by FIG. 16, of operating a twin-row metering system comprising a first seed meter and a second seed meter, with each of the first seed meter and the second seed meter including a motor with a driveshaft and a seed disc operably coupled with the motor via the driveshaft. The method 200 comprises a step S202 measuring a position of the driveshaft of the first motor. A step S204 includes measuring a position of the driveshaft of the second motor. A step S206 includes determining an angular offset between the position of the driveshaft of the first motor and a position of the driveshaft of the second motor. A step S208 includes adjusting a rotational speed of the driveshaft of the second motor based on the determined angular offset. In some embodiments, the memory element of the MCU of the second motor is configured to store computer-readable instructions to perform the determining and adjusting steps of step. Furthermore, the memory element of the MCU of the second motor may be configured to store information indicative of a row spacing and a seed population of the twin-row metering system.

Although the invention has been described with reference to the exemplary embodiments illustrated in the attached drawings, it is noted that equivalents may be employed and substitutions made herein without departing from the scope of the invention as recited in the claims.

1. A method for calibrating a seed meter, said method comprising the steps of:
(a) providing the seed meter and a calibration disc, wherein the seed meter comprises a motor with a driveshaft, and wherein the driveshaft is configured to be positioned by the motor in an uncorrected home position;
(b) engaging the calibration disc with the seed meter, wherein the calibration disc includes a plurality of indicia on a surface of the calibration disc;
(c) identifying a corrected home position for the driveshaft, wherein said identifying of step (c) includes determining, via the indicia of the calibration disc, an angular offset between the uncorrected home position and the corrected home position of the driveshaft.

2. The method of claim 1, further including the step of removing the calibration disc from the seed meter and engaging a seed disc with the seed meter, wherein the seed disc comprises a plurality of pockets positioned around a circumference of the seed disc.

3. The method claim 2, rotating the seed disc, via the motor, to a calibrated home position, wherein the seed disc is located in the calibrated home position when the driveshaft is positioned in the corrected home position.

4. The method of claim 1, wherein the plurality of indicia of the calibration disc is located at least partly around a circumference of the calibration disc, wherein the indicia comprise angular measurement identifiers.

5. The method of claim 4, wherein the indicia extend around at least one-quarter of the circumference of the calibration disc.

6. The method of claim 1, wherein the motor comprises an electric motor.

7. The method of claim 6, wherein the electric motor comprises a processing element and a memory element.

8. The method of claim 7, wherein the memory element is configured to store information indicative of the uncorrected home position of the driveshaft of the motor.

9. The method of claim 7, wherein the memory element is configured to store information indicative of the corrected home position of the driveshaft of the motor, wherein said corrected home position is offset from said uncorrected home position by the angular offset determined in step (c).

10. The method of claim 6, wherein the electric motor comprises an encoder configured to determine a current position of the driveshaft of the motor.

11. The method of claim 1, wherein the seed meter further comprises a disc seat onto which the seed disc and/or the calibration disc can be removably engaged, wherein the disc seat engages with and is rotated by a disc shaft that is engageable with the driveshaft of the motor.

12. A system for calibrating a seed meter, said system comprising:
a housing configured to hold seed;
a disc received within said housing; and
a motor comprising a driveshaft, wherein said motor is configured to rotate said disc,
wherein said disc comprises a plurality of indicia, such that said disc is configured to be used to calibrate a position of said driveshaft of said motor.

13. The system of claim 12, wherein said motor comprises an electric motor.

14. The system of claim 13, wherein said electric motor comprises a processing element and a memory element.

15. The system of claim 14, wherein said memory element is configured to store information indicative of an uncorrected home position of said driveshaft of said motor.

16. The system of claim 15, wherein said memory element is configured to store information indicative of a corrected home position of said driveshaft of said motor, wherein said corrected home position is angularly offset from said uncorrected home position.

17. The system of claim 16, wherein said electric motor comprises an encoder configured to determine a current position of said driveshaft of said motor.

18. The system of claim 12, further comprising a seed disc configured to convey seed via a plurality of pockets positioned around a circumference of said seed disc.

19. The system of claim 12, wherein the plurality of indicia is located at least partly around a circumference of said disc.

20. The system of claim 19, wherein the indicia comprise angular measurement identifiers, and wherein the indicia extend around at least one-quarter of the circumference of said disc.
